(19) United States
(12) Patent Application Publication
(10) Pub. No.: US 2026/0221658 A1
(43) Pub. Date: Jul. 30, 2026

(54) MULTIPLE-FEED ULTRAWIDEBAND BICONICAL ANTENNA

(71) Applicant: Raytheon Company, Arlington, VA (US)

(72) Inventors: David D. Crouch, Farragut, TN (US); Elbert H. Ko, Downey, CA (US)

(21) Appl. No.: 19/036,804

(22) Filed: Jan. 24, 2025

(51) Int. Cl. H01Q 9/28; H01Q 13/04

(52) U.S. Cl. CPC H01Q 9/28; H01Q 13/04

(57) ABSTRACT

A multiple-feed ultrawideband biconical antenna includes a lower cone, an upper cone, and a dielectric member between the lower cone and the upper cone. The multiple-feed ultrawideband biconical antenna also includes a shorting rod extended through the dielectric member and connected to the lower cone below the dielectric member and the upper cone above the dielectric member. The multiple-feed ultrawideband biconical antenna further includes an antenna input having a coaxial interface configured to (i) connect a respective feed line among a set of multiple feed lines to the lower cone and to the upper cone and (ii) transfer an input power from the respective feed line to the antenna.

### TECHNICAL FIELD

This disclosure relates generally to antenna structures. More specifically, this disclosure relates to a multiple-feed ultrawideband biconical antenna.

### BACKGROUND

Conical monopole antennas and biconical antennas are widely used in a variety of applications, such as sensing, communication, and electronic defense systems. When a biconical antenna is used for applications requiring radiation of high-power levels (such as when peak or average power is high), biconical antennas can be limited by at least two factors. First, connectors of coaxial transmission lines limit the power that can be delivered to a monopole by a single feed. While coaxial transmission lines have high power-handling capacity, coaxial connectors do not. Second, a distribution network feeding a conventional single-feed biconical antenna may combine outputs from multiple sources into a single output, but power combiners have power-handling limitations that depend on the frequency of operation, size and weight constraints, etc.

### SUMMARY

This disclosure relates to a multiple-feed ultrawideband biconical antenna.

In a first embodiment, a multiple-feed ultrawideband biconical antenna includes a lower cone, an upper cone, and a dielectric member between the lower cone and the upper cone. The multiple-feed ultrawideband biconical antenna also includes a shorting rod extended through the dielectric member and connected to the lower cone below the dielectric member and the upper cone above the dielectric member. The multiple-feed ultrawideband biconical antenna further includes an antenna input having a coaxial interface configured to (i) connect a respective feed line among a set of multiple feed lines to the lower cone and to the upper cone and (ii) transfer an input power from the respective feed line to the antenna.

In a second embodiment, a system includes a set of multiple feed lines. The system also includes an antenna having a lower cone, an upper cone, and a dielectric member between the lower cone and the upper cone. The antenna also includes a shorting rod extended through the dielectric member and connected to the lower cone below the dielectric member and the upper cone above the dielectric member. The antenna further includes an antenna input having a coaxial interface configured to (i) connect a respective feed line among the set of multiple feed lines to the lower cone and to the upper cone and (ii) transfer an input power from the respective feed line to the antenna.

Any single one or any combination of the following features may be used with the first or second embodiments. A power distribution manifold may be configured to distribute a first power of a first signal to multiple output channels. The set of multiple feed lines can receive multiple input signals from the multiple output channels, and the input signals can have input powers substantially equivalent to one another. The set of multiple feed lines can conduct the input power to the antenna. Each respective feed line among the set of multiple feed lines can include a coaxial transmission line electrically coupled to the lower cone and to the upper cone through the antenna input. The coaxial transmission line of the respective feed line can include an outer conductor electrically coupled to the lower cone and an inner conductor that is electrically coupled to the upper cone and electrically insulated from both the lower cone and the outer conductor. The multiple input signals can have substantially equivalent amplitudes and substantially equivalent phases to one another. Each of the multiple feed lines can be spaced from a center of the shorting rod by a first uniform distance. The multiple feed lines can be spaced apart from each other by a second uniform distance. The antenna can represent a solid biconical antenna, a wire biconical antenna, or a discone antenna. The antenna can represent a conical monopole antenna in which the lower cone is a ground plane. The set of multiple feed lines can include sixteen or more feed lines.

Other technical features may be readily apparent to one skilled in the art from the following figures, descriptions, and claims.

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example radio frequency (RF) power transmission system that includes a multiple-feed ultrawideband (MF-UWB) biconical antenna according to embodiments of this disclosure;

FIG. 2A illustrates a front view of an example MF-UWB biconical antenna according to embodiments of this disclosure;

FIG. 2B illustrates a detailed view according to a first cutaway from a center portion of the MF-UWB biconical antenna of FIG. 2A;

FIG. 3A illustrates a bottom perspective view of the MF-UWB biconical antenna of FIG. 2A;

FIG. 3B illustrates a detailed view according to a second cutaway from the multiple-feed of FIG. 3A;

FIGS. 4A and 4B each illustrates a cutaway view according to the cutline A-A shown in FIG. 2A;

FIG. 4C illustrates a detailed view according to a third cutaway from the center portion of the biconical antenna of FIG. 4A when the dielectric insulation is not shown;

FIGS. 5A, 5B, and 5C respectively illustrate a bottom perspective view, a top view, and a front view of an example MF-UWB wire biconical antenna according to embodiments of this disclosure;

FIGS. 6A and 6B respectively illustrate a front view and a bottom perspective view of an example MF-UWB discone antenna according to embodiments of this disclosure;

FIG. 7A illustrates a bottom perspective view of an example four-feed UWB biconical antenna according to embodiments of this disclosure;

FIG. 7B illustrates a detailed view according to a fourth cutaway from the four-feed UWB biconical antenna of FIG. 7A;

FIG. 8A illustrates a cutaway view according to the cutline B-B shown in FIG. 7A;

FIG. 8B illustrates a detailed view according to a fifth cutaway from a center portion of the four-feed UWB biconical antenna of FIG. 8A;

FIGS. 9A and 9B illustrate example electric field magnitude maps while operating the MF-UWB biconical antenna of FIG. 2A according to embodiments of this disclosure;

FIGS. 10A, 10B, and 10C illustrate various views of the dielectric member of FIG. 2A;

FIGS. 11A, 11B, and 11C illustrate various views of the dielectric components of the biconical antenna with the set of N feed lines of FIG. 3A;

FIGS. 12A, 12B, 12C, 12D, and 12E illustrate the dielectric components of FIGS. 11A-11C together with the center conductors of the coaxial transmission lines shown, but without showing the outer conductors;

FIGS. 13A, 13B, 13C, and 13D illustrate various views of the sector of FIG. 4C; and

FIGS. 14A, 14B, and 14C illustrate various views of an example MF-UWB conical monopole antenna according to embodiments of this disclosure.

### DETAILED DESCRIPTION

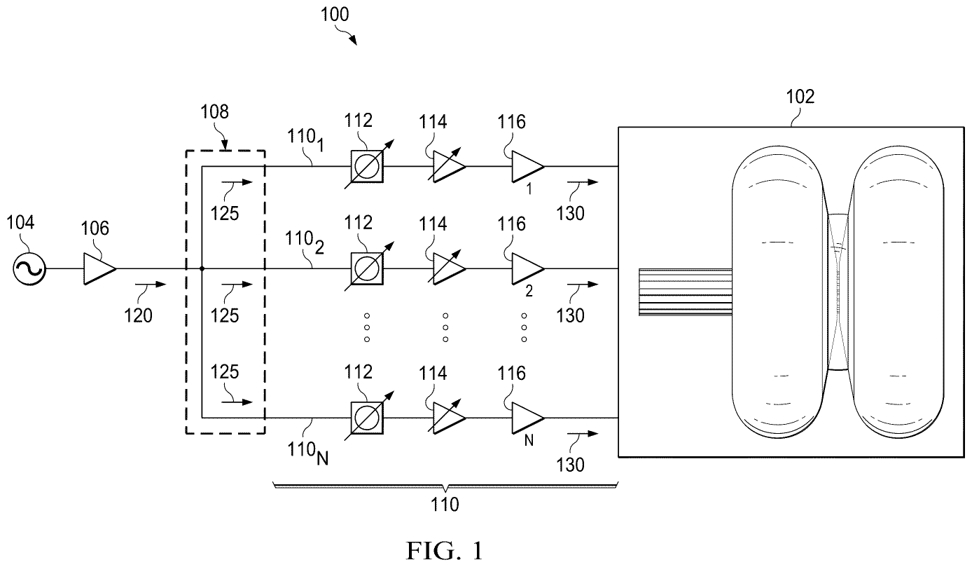

FIGS. 1 through 14B, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As described above, conical monopole antennas and biconical antennas are widely used in a variety of applications, such as sensing, communication, and electronic defense systems. When a biconical antenna used for applications requiring radiation of high-power levels (such as when peak or average power is high), biconical antennas can be limited by at least two factors. First, connectors of coaxial transmission lines limit the power that can be delivered to a monopole by a single feed. While coaxial transmission lines have high power-handling capacity, coaxial connectors do not. Second, a distribution network feeding a conventional single-feed biconical antenna may combine outputs from multiple sources into a single output, but power combiners have power-handling limitations that depend on the frequency of operation, size and weight constraints, etc. Typically, the bandwidth of an antenna degrades as the number of inputs is increased. A typical biconical antenna provides a lot of bandwidth, such as ultrawideband (UWB), but is limited to a single input through a single feed. This disclosure provides a multiple-feed ultrawideband (MF-UWB) biconical antenna, which can be designed to receive multiple inputs through multiple feed lines while preserving the ability to provide a large bandwidth.

FIG. 1 illustrates an example radio frequency (RF) power transmission system 100 that includes a multiple-feed ultrawideband (MF-UWB) biconical antenna 102 according to embodiments of this disclosure. The embodiment of the system 100 shown in FIG. 1 is for illustration only, and other embodiments could be used without departing from the scope of this disclosure.

As shown in FIG. 1, the system 100 includes a master oscillator 104, a preamplifier 106, a power distribution manifold 108, multiple physical paths 110, and the MF-UWB biconical antenna 102. The multiple physical paths 110 include a set of N physical paths 110_1 through 110_N, and each physical path 110_1 through 110_N respectively includes a phase shifter 112, a variable gain amplifier (VGA) 114, and a high-power amplifier (HPA) 116. For simplicity, the set of N physical paths 110 is interchangeably referred as a set of N channels 110 or a set of N feed lines 110.

A signal generated by the master oscillator 104 is amplified by the preamplifier 106 to generate a first signal 120 to be transmitted. The first signal 120 has a first power. The power distribution manifold 108 receives the first signal 120 and distributes the first power of the first signal 120 to N output channels, such as the set of N channels 110. In some embodiments, the preamplifier 106 generates enough power such that power distribution manifold 108 distributes a driving signal 125 (to each of the N output channels) that provides sufficient input power (such as enough power to drive the VGAs 114 into saturation) to VGA 114; and the highest input power levels are generated at the outputs of the HPAs 116 as input signals 130. In other embodiments, which are described more particularly in this disclosure, the preamplifier 106 is a high-power amplifier that outputs the first signal 120, which constitutes a total RF output of the system 100, and within such embodiments, the system 100 does not include phase shifters 112, VGAs 114, and HPAs 116, thereby eliminating the driving signals 125 as being the input signals 130 that are distributed to the biconical antenna 102. That is, the power distribution manifold 108 generates N input signals 130 by distributing the first power to the set of N channels 110. To distribute the first power to the set of N channels 110, the power distribution manifold 108 can divide the first power by the number N, thereby generating an input power (1/N of the first power) for each input signal 130. The power distribution manifold 108 outputs the N input signals to the set of N physical paths 110. As a result, the first signal 120 is shared among the set of N physical paths 110 as the N input signals 130.

To enable the first signal 120 to be transmitted by the MF-UWB biconical antenna 102, the N physical paths 110 couple the biconical antenna 102 to the power distribution manifold 108. One end of the set of N physical paths 110 is coupled to the power distribution manifold 108 to enable the first signal 120, in the form of the N input signals 130, to feed into the set of N physical paths 110. The other end of the set of N physical paths 110 is coupled to the MF-UWB biconical antenna 102 to enable the biconical antenna 102 to receive the N input signals 130 as input. Each feed line 110_1 through 110_N includes a coaxial transmission line that has power-handling limitations of a single coaxial feed. The N feed lines 110 together conduct N times the input power of a single feed line to the biconical antenna 102. In other words, the set of multiple feed lines has a power-carrying capacity that is N times that of a single feed line, where N is the number of feed lines. The set of multiple feed lines can be configured to output multiples more than the input power to a single antenna input. Embodiments of this disclosure distribute the first power of the first signal 120 (as N input powers) over a volume, reducing risk of damage due to high peak or average power inputs.

The biconical antenna 102 receives the N input signals 130 through an antenna input. The antenna input includes a coaxial interface that connects a respective feed line 110_1 among the set of N feed lines 110 to both lower and upper cones of the biconical antenna 102. The coaxial interface also transfers an input power (within an input signal 130) from the respective feed line 110_1 to the biconical antenna 102. Particularly, when the coaxial interface transfers the input power from the respective feed line to the biconical antenna 102, the lower and upper cones carry RF currents delivering the power carried by the electric fields contained between the lower and upper cones. In some embodiments, the antenna input includes a set of N coaxial interfaces that receives the N input signals 130, respectively. The biconical antenna 102 is configured to radiate radio frequency (RF) energy from the lower and upper cones. That is, the lower and upper cones together form a radiator. Improved or optimal performance of the biconical antenna 102 may be realized when amplitudes and phases of the N input signals 130 are identical at the antenna input. That is, improved or optimal performance may be realized when all feed lines 110 are energized simultaneously and uniformly (electrically equivalent to each other).

In some cases, the system 100 is configured to equalize the physical path lengths of the set of N feed lines 110. For example, the system 100 may use the phase shifters 112 and VGAs 114 to reduce or minimize input-to-input amplitude and phase variations. As a particular example, the phase shifters 112 may reduce input-to-input phase variations in order for the N input signals 130 to have a phase substantially equivalent to each other. In order for the N input signals 130 to have an input power substantially equivalent to one another, the system 100 can reduce input-to-input amplitude variations by using the VGAs 114. In some embodiments, a VGA 114 can be replaced by a combination of a variable attenuator and an amplifier (such as the high-power amplifier 116). In some embodiments, if additional gain is not needed, a VGA 114 can be replaced by a variable attenuator without the amplifier.

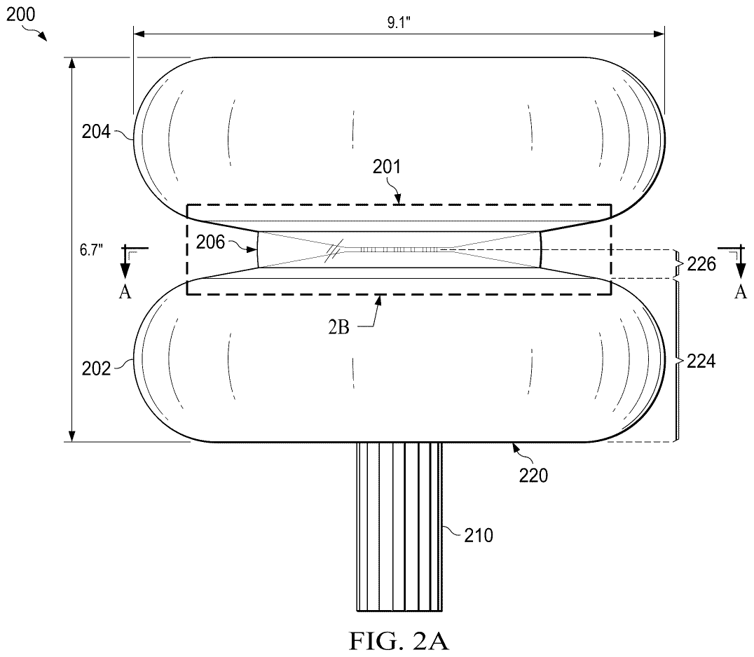

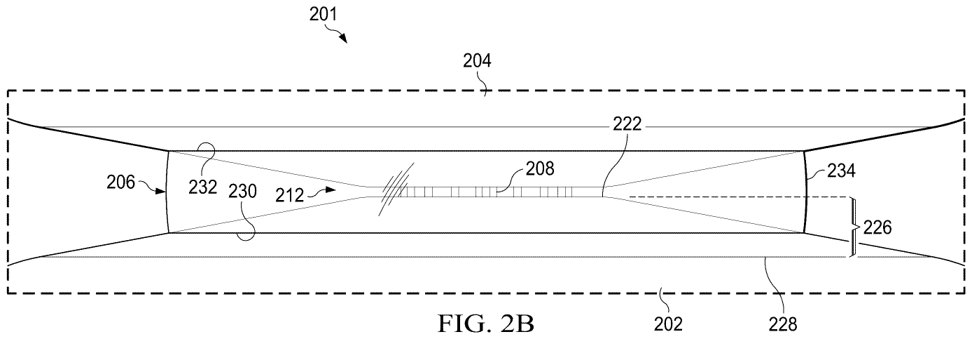

FIGS. 2A through 4C illustrate various details of a MF-UWB biconical antenna 200 that represents a solid biconical antenna, which can have a solid surface and a hollow interior to reduce weight. The hollow interior can be a space that contains air or some other lightweight material, and the space is bounded by the solid surface. In some embodiments, the MF-UWB biconical antenna 200 can represent the biconical antenna 102 of FIG. 1. The power-handling limitations of a single MF-UWB biconical antenna can be mitigated by using multiple MF-UWB biconical antennas to realize spatial power combining function.

FIG. 2A illustrates a front view of the MF-UWB biconical antenna 200 according to embodiments of this disclosure. FIG. 2B illustrates a detailed view according to a first cutaway 201 from a center portion of the MF-UWB biconical antenna 200 of FIG. 2A. As shown in FIGS. 2A and 2B, the biconical antenna 200 includes a lower cone 202, an upper cone 204, a dielectric member 206, and a shorting rod 208. In some embodiments, the biconical antenna 200 includes a set of N feed lines 210 that includes multiple feed lines, and the biconical antenna 200 includes an antenna input interface 212 that is physically and electrically connected to each respective feed line among the set of N feed lines 210. In other embodiments, the biconical antenna 200 includes the antenna input interface 212 without the set of N feed lines 210, in which case the antenna input interface 212 is configured to physically and electrically connect to the set of N feed lines 210.

The lower cone 202 includes a first solid surface that conducts RF currents received from N input signals 130 fed through the set of N feed lines 210 and the antenna input interface 212. The upper cone 204 includes a second solid surface that conducts RF currents received from the N input signals 130 fed through the set of N feed lines 210 and the antenna input interface 212. In the example shown, the lower cone 202 and the upper cone 204 face each other and are aligned symmetrically about a center longitudinal axis of symmetry (such as the center of the shorting rod 208).

In some embodiments, the shape of the upper cone 204 is the same as the shape of the lower cone 202. The shape of the lower cone 202 includes a flat bottom surface 220, a flat top surface 222, and an annular side surface that extends from the bottom surface 220 to the top surface 222. The bottom surface 220 and the top surface 222 are circular and orthogonal to the center longitudinal axis. The side surface of the lower cone 202 includes a lower portion 224 that is a curved semi-circularly and an upper portion 226 that is conical. The lower portion 224 extends from the bottom surface 220 to a base 228 of the conical upper portion 226. From its base 228 to its truncated apex, the conical upper portion 226 extends from the lower portion 224 to the top surface 222. In some embodiments, the biconical antenna 200 may be about 6.7 inches (17.2 centimeters) high and about 9.1 inches (23.1 centimeters) wide, but larger or smaller dimensions are possible. Also, in some embodiments, the lower cone 202 and the upper cone 204 can have substantially the same width and height as one another.

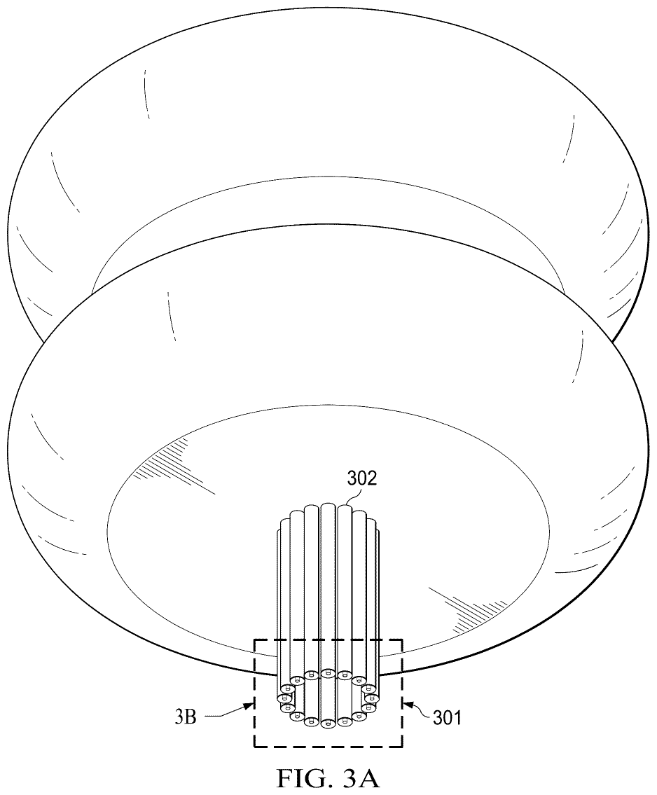

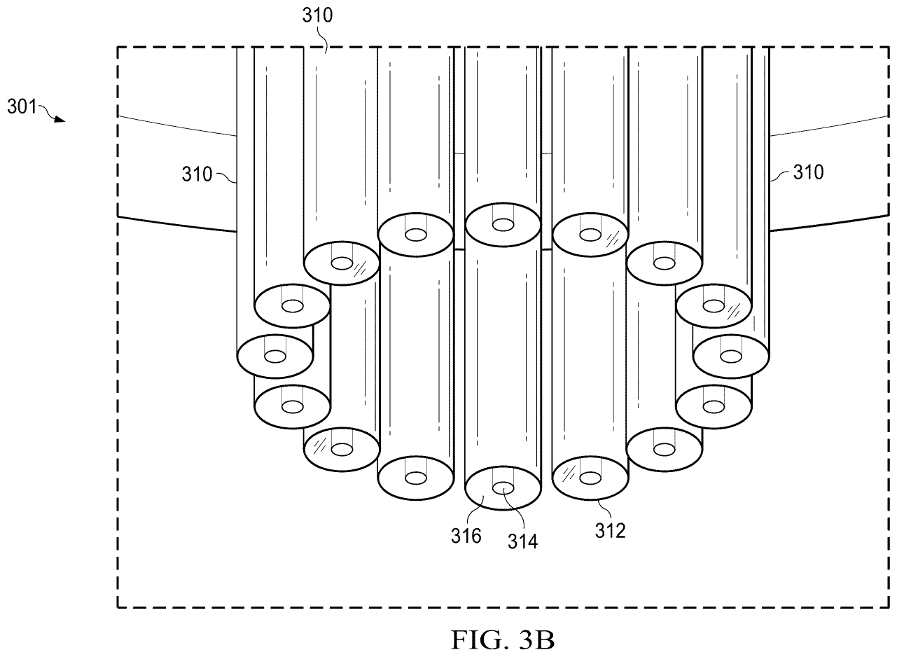

The size and shape of the dielectric member can be varied along with other geometric parameters to increase bandwidth (for example, to maximize bandwidth). The dielectric member 206 is composed of a dielectric insulation material located between the lower cone 202 and the upper cone 204. The dielectric member 206 provides electrical insulation where electric fields are concentrated, such as between the lower and upper cones 202 and 204. The dielectric member 206 may also optionally provide mechanical support for the upper cone 204. The dielectric member 206 can help to prevent breakdown by providing a dielectric strength higher than that of the air it displaces and by allowing electric fields from a center conductor (shown in FIG. 3B) of each coaxial transmission line to spread out along a path from the center conductor to an air-dielectric member interface.

In this example, the dielectric member 206 includes a bottom surface 230 adjacent to (such as in contact with) the upper portion 226 of the annular side surface of the lower cone 202, a top surface 232 opposite to the bottom surface 230, and an annular side surface 234 that extends from the bottom surface 230 to the top surface 232. The side surface 234 forms the air-dielectric member interface. The dielectric member 206 can have any suitable shape, such as a disk shape or a shape that corresponds to (for example, mates with) adjacent portions of the lower and upper cones 202 and 204, such as the adjacent upper portion 226.

In some embodiments, the biconical antenna 200 can be built with a dielectric member 206 that includes air between the lower and upper cones 202 and 204 rather than the dielectric member 206 being a solid dielectric structure. Unlike the solid dielectric structure, air does not provide mechanical support for the weight of the upper cone 204 to prevent the upper cone 204 from contacting the lower cone 202. Also, in cases in which the first signal 120 includes a first power that is high, the input power 130 is increased proportionally, and the air could be ionized and transformed into plasma, thus breaking down.

The shorting rod 208 extends through the dielectric member 206. The shorting rod 208 is connected to the lower cone 202 below the dielectric member 206 and is connected the upper cone 204 above the dielectric member 206.

FIG. 3A illustrates a bottom perspective view of the MF-UWB biconical antenna 200 of FIG. 2A. The bottom of the lower cone 202 includes a pass-through hole 302 that is large enough to fit the set of N feed lines 210. The dimensions of the pass-through hole 302 may physically limit the number of feed lines within the set of N feed lines 210 based on the dimensions of the coaxial transmission line used for each feed line. In this example, the biconical antenna 200 includes a set of sixteen feed lines 210 symmetrically arranged as shown in the second cutaway 301.

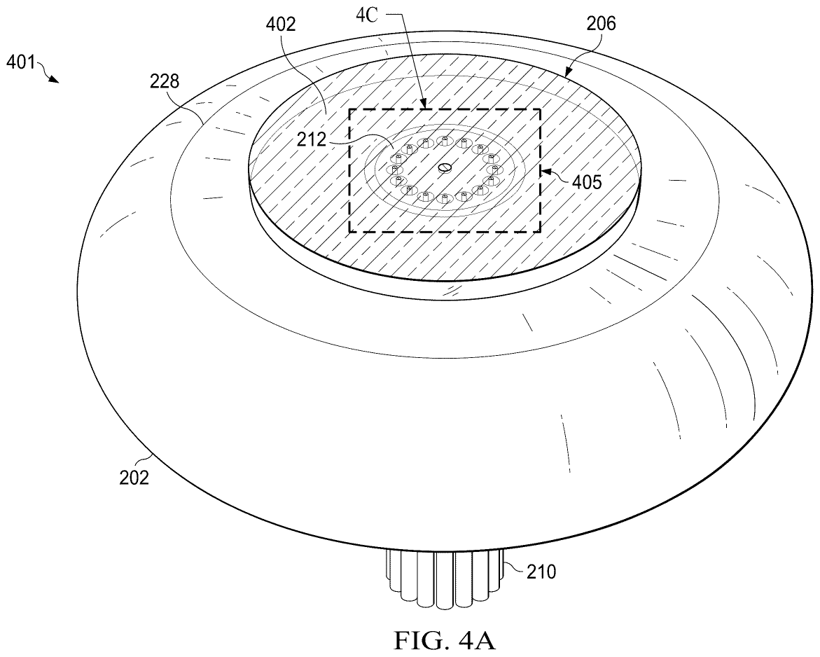

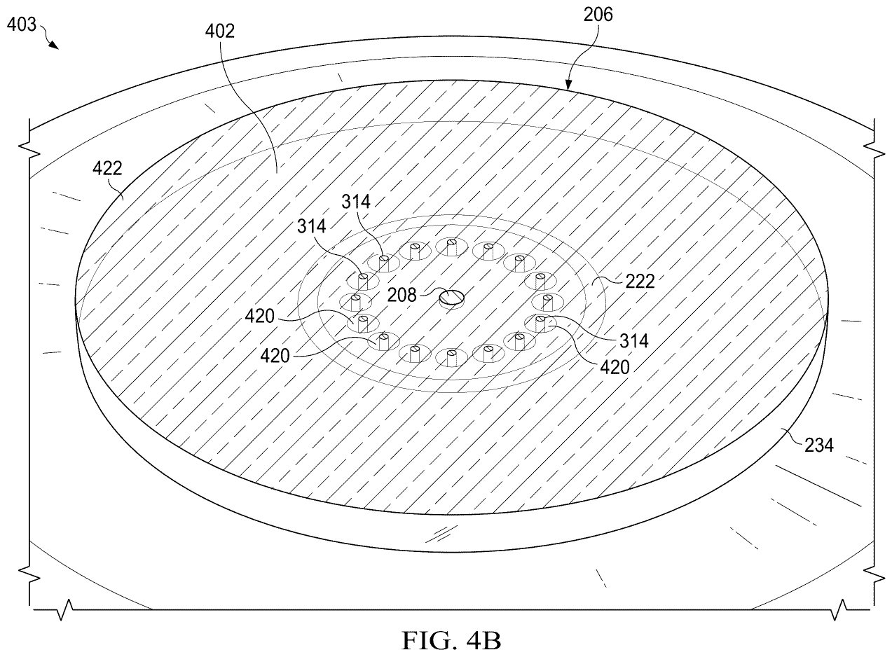

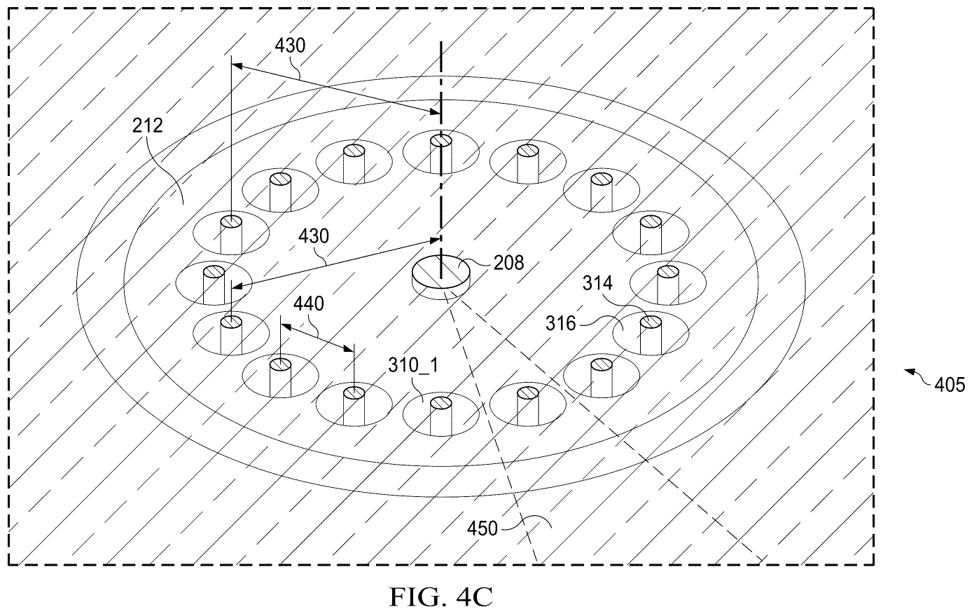

Although FIG. 3A illustrates one example of a bottom perspective view of the MF-UWB biconical antenna 200 of FIG. 2A, various changes may be made to FIG. 3A. As a particular example, a pass-through hole 302 can be replaced by a set of N pass-through holes that includes a respective pass-through hole for each coaxial transmission line. Among the set of N pass-through holes, the center of each respective pass-through hole may lie on a circle centered about the axis of symmetry of the biconical antenna. The number of feed lines may be limited by the feed line diameters and by the center-to-center distance (second uniform distance 440 of FIG. 4C) between adjacent feed lines.

FIG. 3B illustrates a detailed view according to a second cutaway 301 from the multiple feeds of FIG. 3A. Among the set of N feed lines 210, each respective feed line includes a coaxial transmission line 310. The coaxial transmission line 310 includes an outer conductor 312, a center conductor 314, and a dielectric insulator sleeve 316 electrically isolating the outer conductor 312 from the center conductor 314. The outer conductor 312 is in physical contact with the lower cone 202, is electrically coupled to the lower cone 202, and has the same electrical potential as the lower cone 202. Analogously, the center conductor 314 is in physical contact with the upper cone 204, is electrically coupled to the upper cone 204, and has the same electrical potential as the upper cone 204. As such, each coaxial transmission line 310 is parallel to each other electrically and spatially (such as spatially with respect to the longitudinal axis). Except for the dielectric member 206 and the dielectric insulator sleeve 316, the other components of the biconical antenna 200 may be good electrical conductors, such as metal.

FIGS. 4A and 4B each illustrates a cutaway view 401 according to the cutline A-A shown in FIG. 2A. Referring to FIG. 4A, the cutline A-A is through a lateral center of the dielectric member 206. The cutaway view 401 is from a point of view at the cutline A-A down toward the lower cone 202. In the cutaway view 401, the dielectric member 206 is illustrated as translucent in order for a portion of the antenna input interface 212 to be shown, but the dielectric member 206 can have any amount of opacity. The bottom edge 402 at the perimeter of dielectric member 206 shows that the dielectric member 206 is concentric with the lower cone 202 and has a diameter that is less than the diameter of the base 228 of the upper portion 226 of the lower cone 202.

FIG. 4B shows a close-up view 403 from the cutaway view 401. The close-up view 403 shows a lateral cross section of each coaxial transmission line 310 at the cutline A-A, where the lateral cross-section view shows the solid material (metal conductor) of the center conductors 314 and the shorting rod 208. The center conductors 314 and the shorting rod 208 protrude beyond the top surface 222 of the lower cone 202 and extend through the dielectric member 206 in order to connect to the upper cone 204. The lateral cross section of each coaxial transmission line 310 at the cutline A-A also shows a coaxial interface 420 at the location where the outer conductor 312 and the dielectric insulator sleeve 316 contact the bottom surface of the dielectric member 206. In this particular example, the outer conductor 312 and the dielectric insulator sleeve 316 of each coaxial transmission line 310 do not extend beyond the top surface of the lower cone 202 and stop at respective electrical connections to the lower cone 202.

The shorting rod 208 need not carry the input signal 130 or any portion of the first signal 120. The shorting rod 208 is electrically connected to and physically contacts the lower cone 202. Also, the shorting rod 208 is electrically connected to and physically contacts the upper cone 204. That is, one end of the shorting rod 208 has the same electrical potential as the lower cone 202, and the other end of the shorting rod 208 has the same electrical potential as the upper cone 204. Among other things, the shorting rod 208 may enhance the bandwidth of the biconical antenna 200. For example, bandwidth may be improved by the shorting rod 208 connecting the upper and lower cones along the axis of symmetry. In addition, as an example of the thickness of the air-dielectric member interface, the close-up view 403 shows a partial thickness from the bottom edge 402 of the side surface 234 and top edge 422 of the cutline A-A through the dielectric member 206. For example, the cutline A-A cuts the dielectric member 206 in two, such as at half of the thickness the dielectric member 206.

FIG. 4C illustrates a detailed view according to a third cutaway 405 from the center portion of the biconical antenna of FIG. 4A when the dielectric insulation is not shown. The set of N feed lines 210 are symmetrically arranged with respect to the center longitudinal axis of the biconical antenna 200 (which can be the center of the shorting rod 208) as shown in the antenna input interface 212 in the third cutaway 405. Each of the N feed lines 210 includes a coaxial transmission line 310 that is spaced from the center of the shorting rod 208 by a first uniform distance 430. The set of N feed lines 210 are spaced apart from each other by a second uniform distance 440. This circular symmetry of the antenna input interface 212 allows one sector 450 of the antenna input interface 212 (such as 1/N of the antenna input), which includes a single coaxial interface, to be substantially equal to all other sectors. Such symmetry allows for simplified design. The sector 450 includes single feed line 310_1, the coaxial interface that connects the coaxial transmission line of the feed line 310_1 to the lower cone 202, and a 22.5° slice (360°/16) of the shorting rod 208. The vertical sides of the sector 450 represent symmetry planes that mimic a perfect magnetic conductor; magnetic fields tangential to the boundary are zero while tangential electric fields are symmetric on either side of the boundary. For example, the vertical sides of the sector 450 represent a symmetrical effect of other feed lines 210 that are coupled to and arranged within the antenna input interface 212 and energized (such as conducting the input signal 130). Power conducted through the single feed line 310_1 and the 1/N slice of the shorting rod 208 within sector 450 represents each other sector based on an assumption that all others of the feed lines 210 are energized with the same amplitude and phase as the feed line 310_1 contained within sector 450.

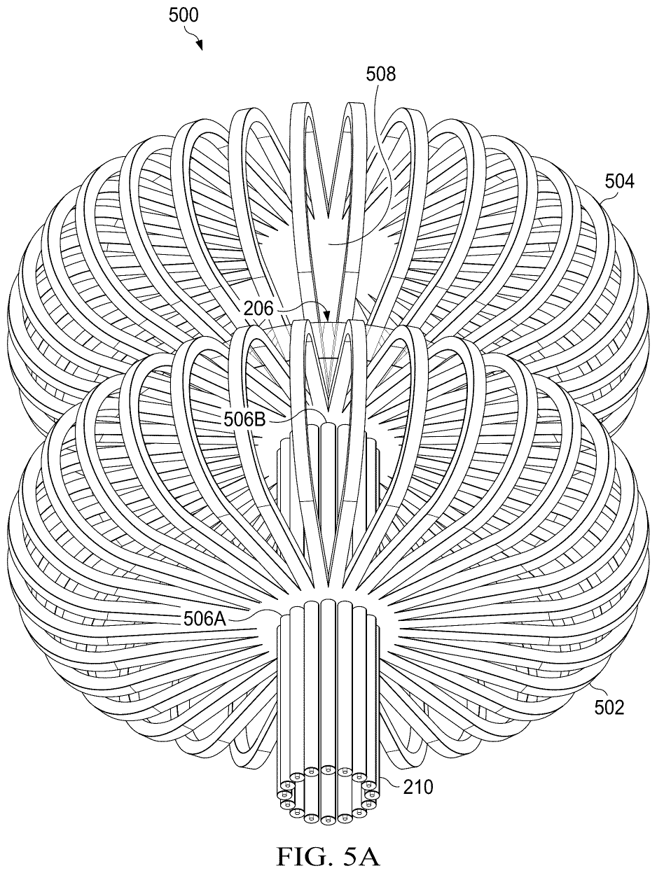

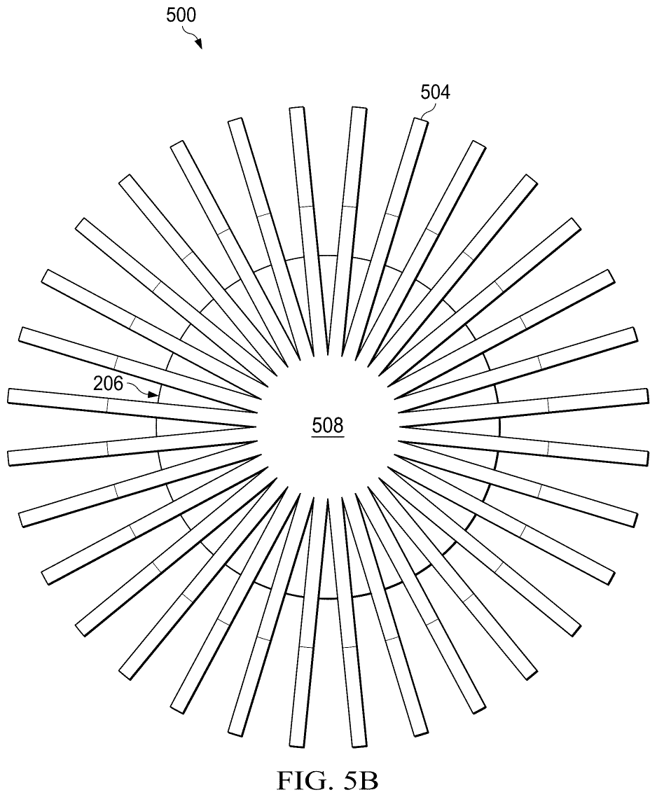

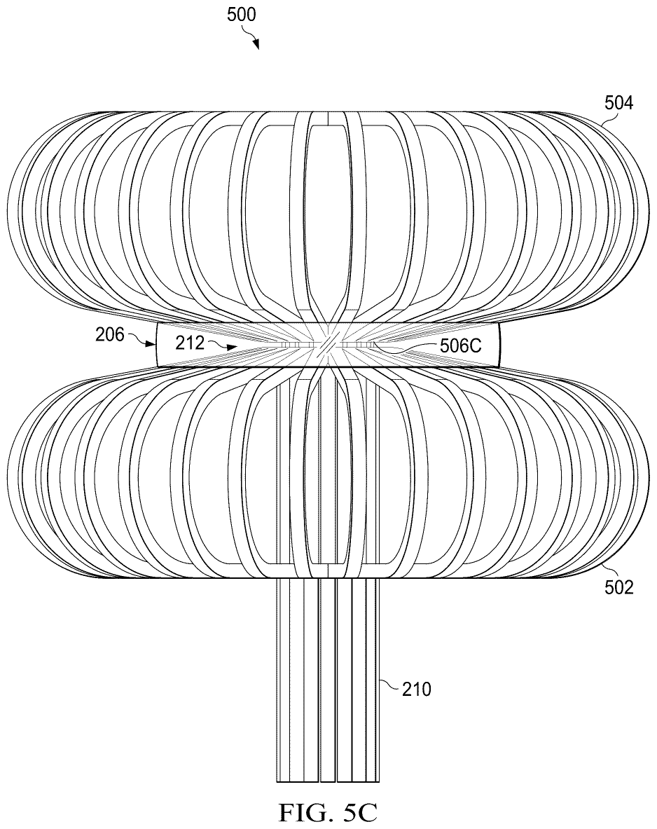

FIGS. 5A, 5B, and 5C respectively illustrate a bottom perspective view, a top view, and a front view of a MF-UWB wire biconical antenna 500 according to embodiments of this disclosure. The embodiment of the MF-UWB wire biconical antenna 500 shown in FIGS. 5A, 5B, and 5C is for illustration only, and other embodiments could be used without departing from the scope of this disclosure. The wire biconical antenna 500 is similar to the solid biconical antenna 200 of FIG. 2A and includes the same dielectric member 206, set of N feed lines 210, and antenna input interface 212. However, the surfaces of upper and lower cones are composed of multiple wires spaced apart from each other instead of a solid sheet. Within the wire biconical antenna 500, the lower cone includes multiple first wires 502 that conduct RF currents received from the N input signals 130 fed through the outer conductors 312 of the set of N feed lines 210 and the antenna input interface 212. The upper cone 204 includes multiple second wires 504 that conduct RF currents received from the N input signals 130 fed through the center conductor 314 of the set of N feed lines 210 and the antenna input interface 212.

The bottom ends of the first wires 502 are connected to each other to form a first ring 506a that includes a pass-through hole 302. The top ends of the first wires 502 are connected to each other to form a second ring 506b that includes another pass-through hole 302. Similarly, the bottom end of the second wires 504 form a third ring 506c (FIG. 5C) that includes a pass-through hole 302. The top ends of the second wires 504 are connected to each other to form a solid plate 508.

The antenna input interface 212 electrically connects the outer conductors 312 within the set of N feed lines 210 to the lower cone (such as the first wires 502) at the second ring 506b, and can additionally electrically connect the outer conductors 312 to the first ring 506a. The antenna input interface 212 electrically connects the center conductors 314 of the set of N feed lines 210 to the upper cone (such as the second wires 504) at the third ring 506c. In some embodiments, the set of N feed lines 210 stop at the third ring 506c and do not extend through the body of the upper cone.

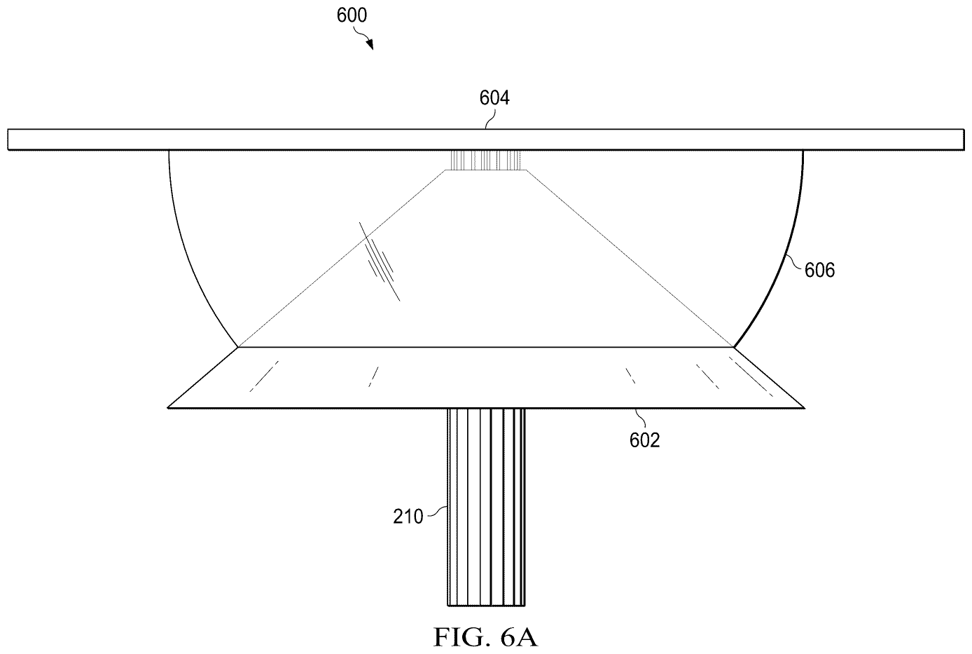

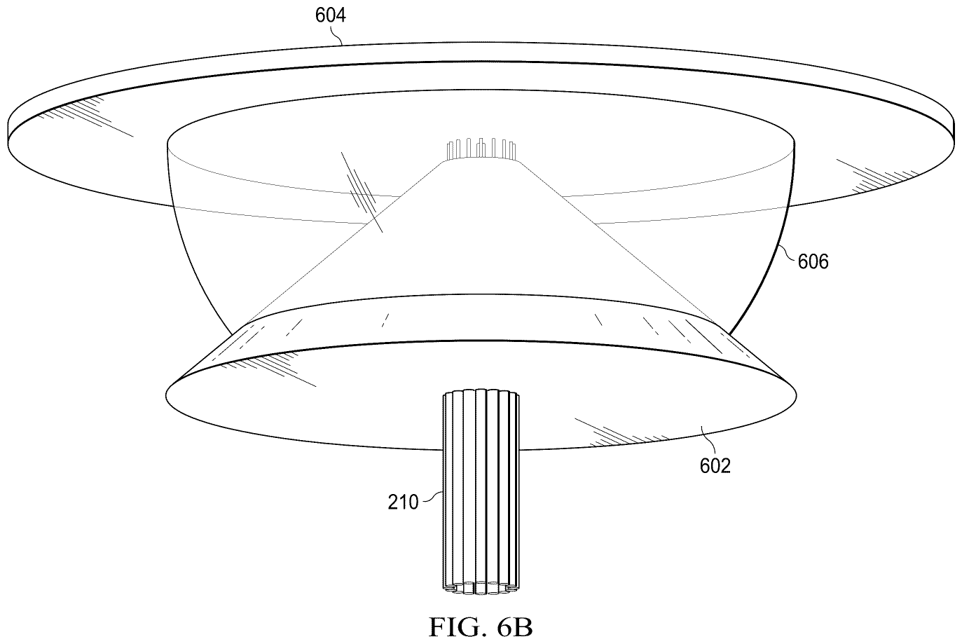

In a MF-UWB biconical antenna, the shape of the upper cone can be different from the shape of the lower cone. A discone antenna is a biconical antenna in which one cone is replaced by a disc. FIGS. 6A and 6B respectively illustrate a front view and a bottom perspective view of a MF-UWB discone antenna 600 according to embodiments of this disclosure. The embodiment of the MF-UWB discone antenna 600 shown in FIGS. 6A and 6B is for illustration only, and other embodiments could be used without departing from the scope of this disclosure. The discone antenna 600 is similar to the solid biconical antenna 200 of FIG. 2A and includes the same set of N feed lines 210 and antenna input interface 212. However, upper and lower cones 604 and 602 are shaped as a disc and a circular cone, respectively.

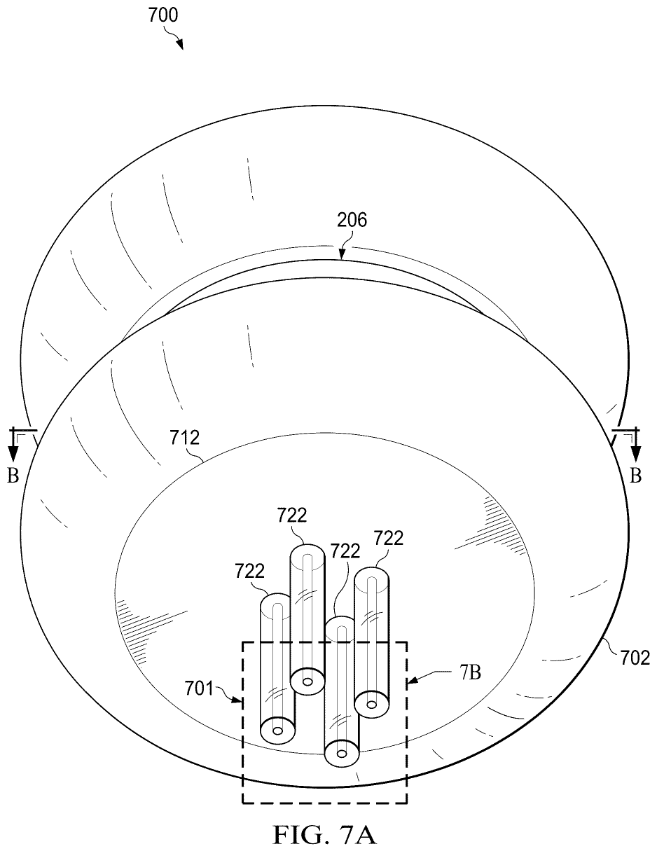

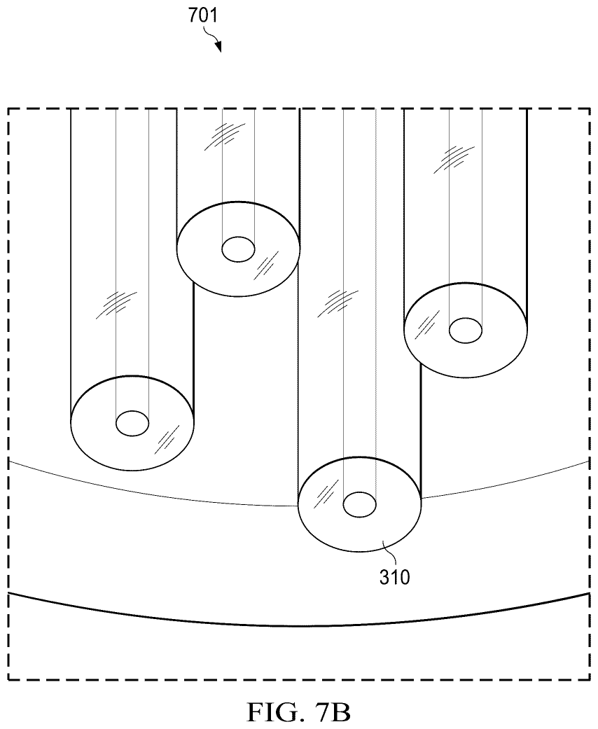

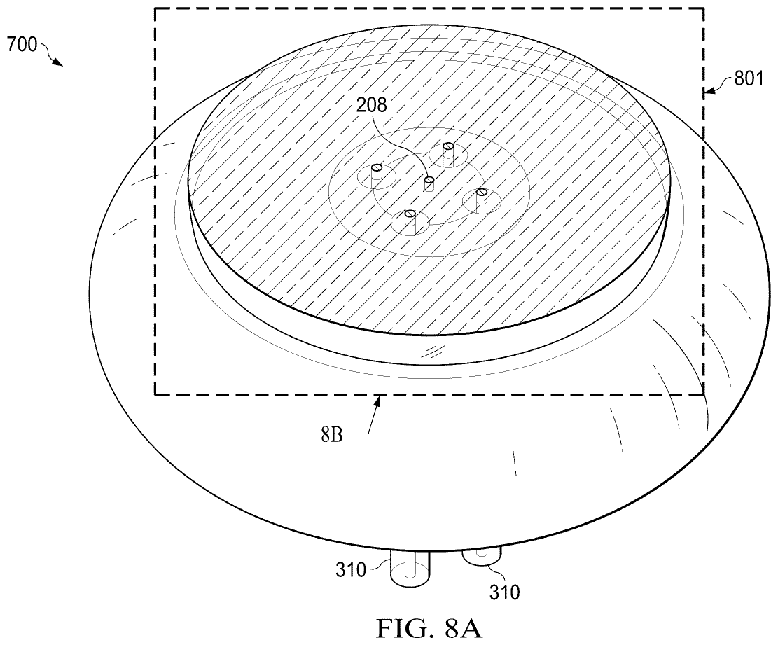

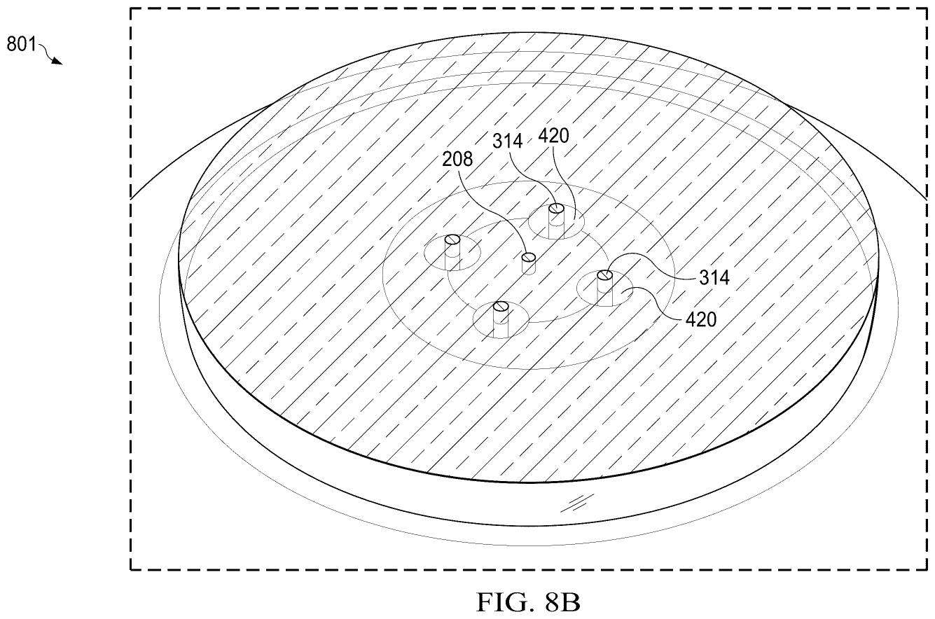

FIGS. 7A, 7B, 8A, and 8B illustrate various details of a four-feed UWB biconical antenna 700 according to embodiments of this disclosure. The four-feed UWB biconical antenna 700 is similar to the solid biconical antenna 200 of FIG. 2A. However, the number of feed lines is different. Embodiments having four, eight, sixteen, or other numbers of feed lines may be used here. For example, the number of feed lines can be a number that is not an even number or not a power of two.

FIG. 7A illustrates a bottom perspective view of the four-feed UWB biconical antenna 700 according to embodiments of this disclosure. FIG. 7B illustrates a detailed view according to a fourth cutaway 701 from the four-feed of FIG. 7A. Similar to the sixteen-feed antenna input interface 212 of FIG. 2B in which each coaxial transmission line 310 among of the set of feed lines is separated by 360°/N, the four-feed antenna interface 712 in FIG. 7A corresponds to four respective coaxial transmission lines 310 that form a set of four feed lines separated by 90°. The pattern of the radiation from the four-feed UWB biconical antenna 700 can have a clover-leaf shape (associated with N=4 feed lines) instead of a circular shaped radiation pattern (associated with N=16 feed lines). In this example, the bottom of the lower cone 702 includes N pass-through holes 722, where each pass-through hole 722 is large enough for one coaxial transmission line 310.

Referring to FIG. 7A, the cutline B-B is through a lateral center of the dielectric member 206. The cutline B-B is at a similar location as the cutline A-A of FIG. 2A. Referring to FIG. 8A, the cutaway view 801 is from a point of view at the cutline B-B down toward the lower cone 702. In the cutaway view 801, the dielectric member 206 is illustrated as translucent in order for a top portion of the four-feed antenna interface 712 to be shown, but the dielectric member 206 can have any amount of opacity.

FIG. 8A illustrates a cutaway view according to the cutline B-B shown in FIG. 7A. FIG. 8B illustrates a detailed view according to a fifth cutaway from a center portion of the four-feed UWB biconical antenna of FIG. 8A. FIGS. 8A and 8B are similar to FIGS. 4A and 4B, respectively. That is, the lateral cross section of each coaxial transmission line 310 at the cutline B-B also shows a coaxial interface 420 at the location where the outer conductor 312 and the dielectric insulator sleeve 316 end and contact the bottom surface of the dielectric member.

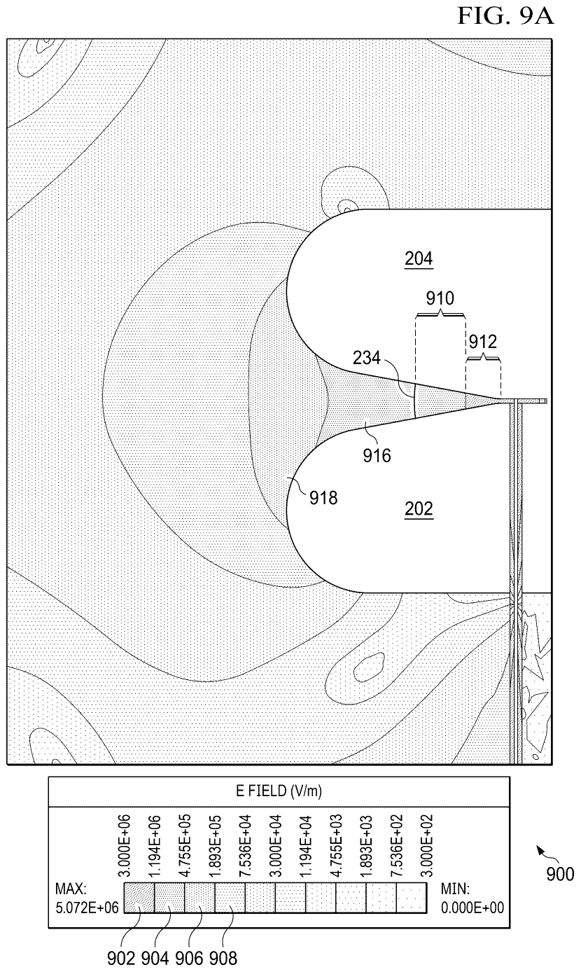

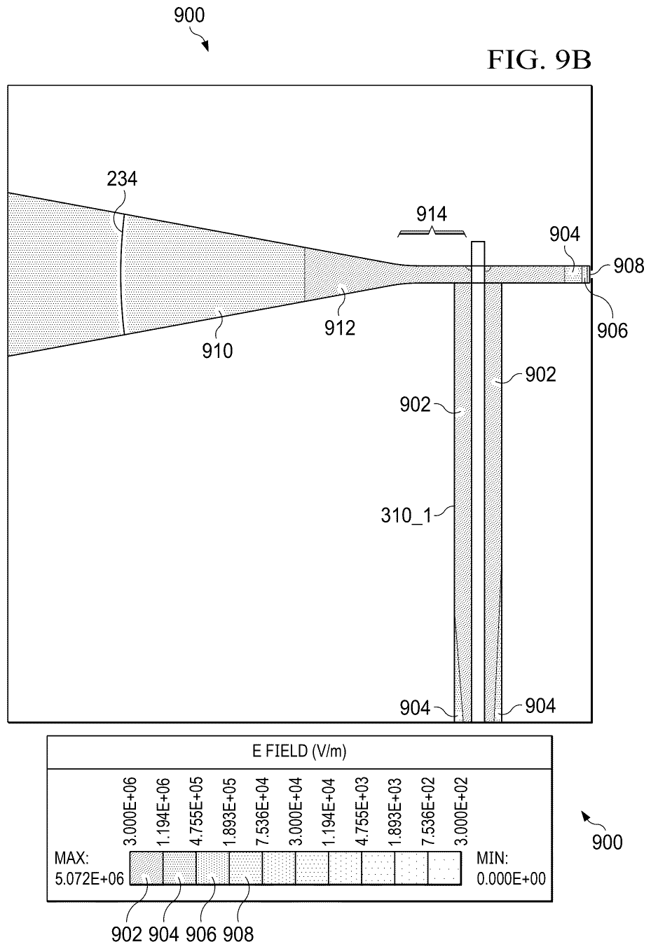

FIGS. 9A and 9B illustrate electric field magnitude map 900 while simulating an operation of the MF-UWB biconical antenna 200 of FIG. 2A according to embodiments of this disclosure. FIG. 9B shows a close-up view of electric field magnitude map 900 of FIG. 9A. The electric field magnitudes shown in FIGS. 9A and 9B are in dielectric or in air. In some embodiments, the electric field inside a conductor is zero. The electric field magnitude map 900 shows a high first value 902 of electric field magnitude within the feed line 310_1. The high first value 902 can be a maximum field strength of the power-handling limitations of the coaxial transmission line. A legend shows various electric field levels (such as a range of electric field values) in units of volts per meter. A second value 904 of electric field magnitude is less than the high first value 902.

The electric field magnitude within some regions of the dielectric member 206 have a third value 906 and a fourth value 908. The third value 906 is greater than the fourth value 908 and less than the second value 904. The electric field magnitude within an outer region 910 and an intermediate region 912 of the dielectric member 206 have the third value and the second value, respectively. The air-dielectric member interface at the side surface 234 of the dielectric member 206 shows that immediate air 916 between the lower and upper cones 202 and 204 has the third value 906 of the electric field magnitude, which is a lower electric field magnitude outside of the dielectric member 206 than the higher electric field magnitude confined within the intermediate and central regions 912 and 914 of the dielectric member 206. This confinement of higher electric field magnitudes to within the dielectric member 206 is a technical advantage to prevent air breakdown.

The electric field magnitude within the central region 914 of the dielectric member 206 has the high first value 902. The high electric fields in the central region 914 of the dielectric member 206 can be where the outer conductor 312 of the feed line 310_1 electrically connects to the lower cone 202. The fourth value 908 is the electric field magnitude within outer air 918, which is located radially further outside of the lower and upper cones 202 and 204 and which is beyond the immediate air 916.

Although the map 900 of electric field magnitude is in and around the MF-UWB biconical antenna 200 of FIG. 2A, the same or similar electric field magnitude distributions within the dielectric member 206 may apply to or represent other MF-UWB biconical antennas 500, 600, 700. Each of these biconical antennas utilizes multiple parallel coaxial feed lines to mitigate the power-handling limitations of a conventional biconical antenna having a single coaxial feed. The power limitation imposed by the coaxial interface remains. However, with the input power shared among N parallel feed lines, the total power that can be delivered to the biconical antenna without failure of a feed-line is increased approximately N times. Embodiments of this disclosure significantly increase power handling capacity over a wide operating bandwidth while decreasing the power-carrying burden on individual transmission lines, compared to a single feed antenna.

According to certain embodiments of this disclosure, no overt impedance-matching elements are required. Rather, the input impedance of a multiple-feed monopole is matched to those input impedances of the coaxial feed lines by tailoring the antenna geometry, configuring the first uniform distance 430 of the feed lines from the axis of symmetry and configuring the shape of the lower and upper cones themselves.

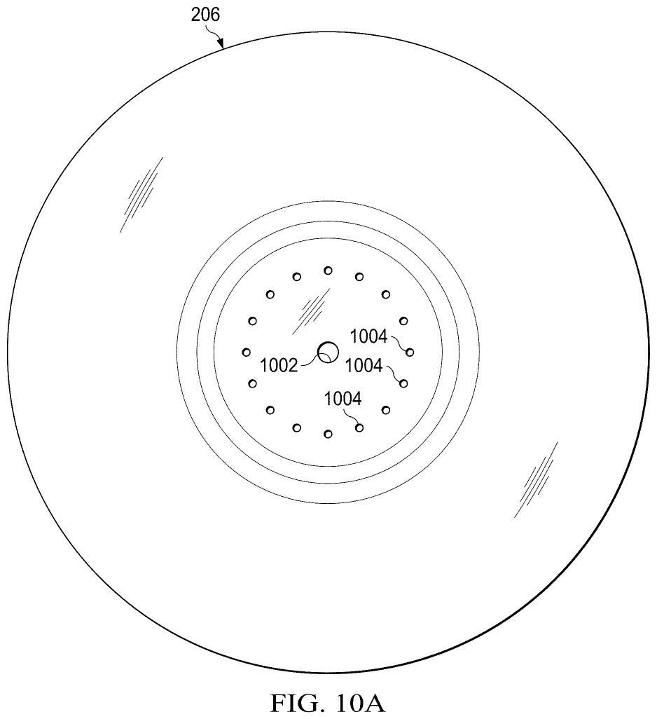

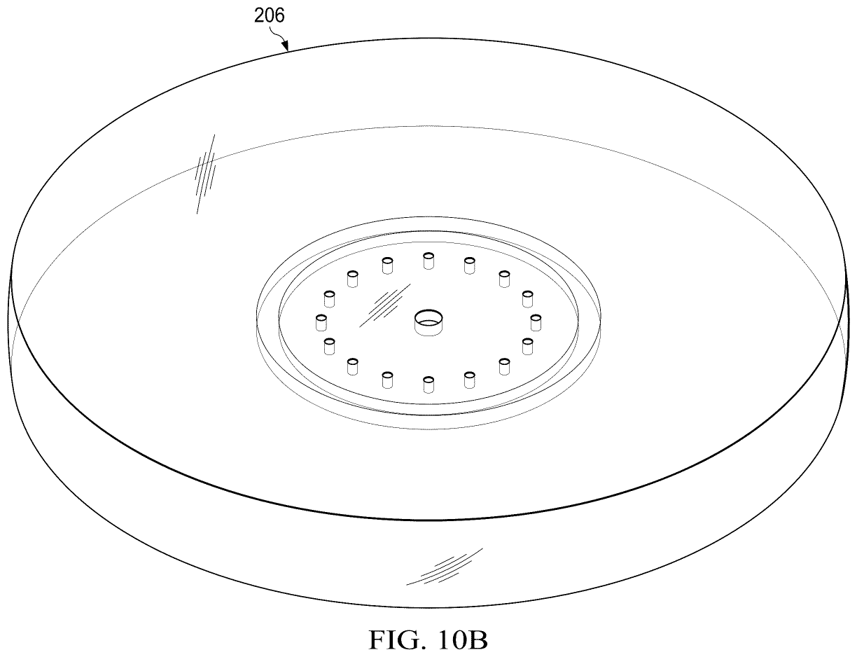

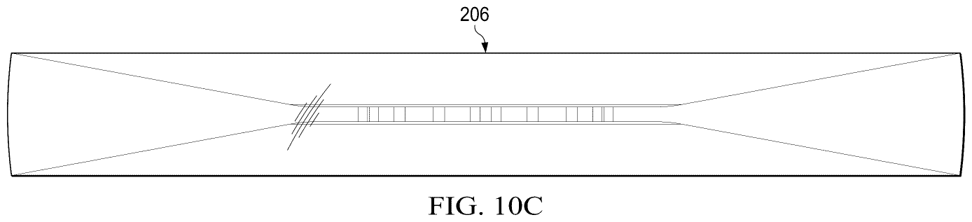

FIGS. 10A, 10B, and 10C illustrate various views of the dielectric member 206 of FIG. 2A. FIG. 10A illustrates a top view of the dielectric member 206. FIG. 10B illustrates a top perspective view of the dielectric member 206. FIG. 10C illustrates a side view of the dielectric member 206. In this example, the only holes 1002-1004 through the dielectric member 206 accommodate the shorting rod 208 and the center conductors 314 passing through. Particularly, the shorting rod 208 passes through the center hole 1002, and the N center conductors 314 pass through the holes 1004, respectively. The center hole 1002 accommodates the shorting rod 108 by having a diameter that is approximately the same as the diameter of the shorting rod 208, and analogously, the diameters of the holes 1004 are approximately the same as the diameter of the center conductors 314, respectively.

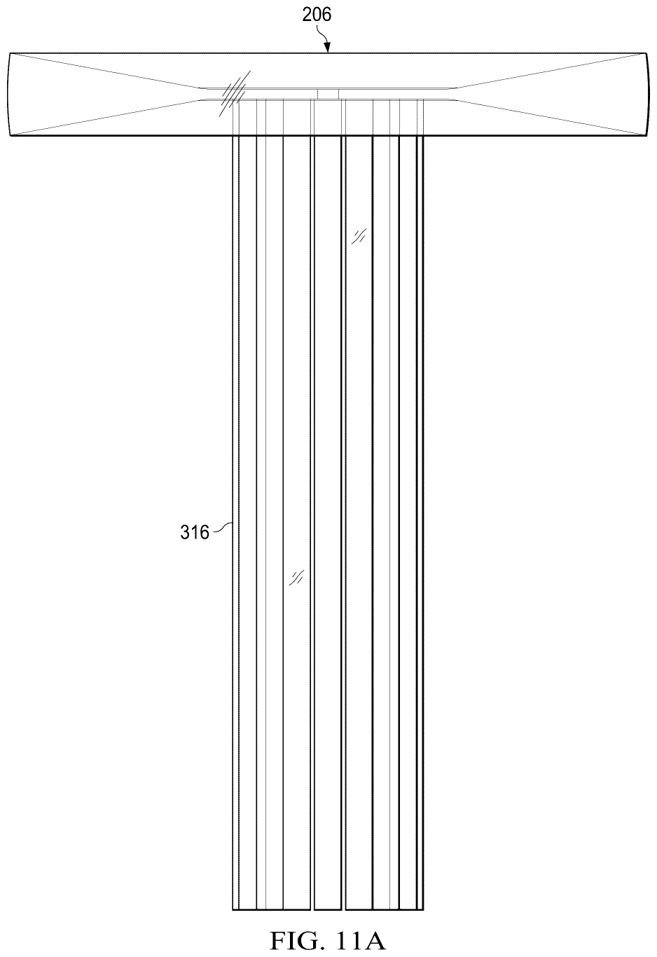

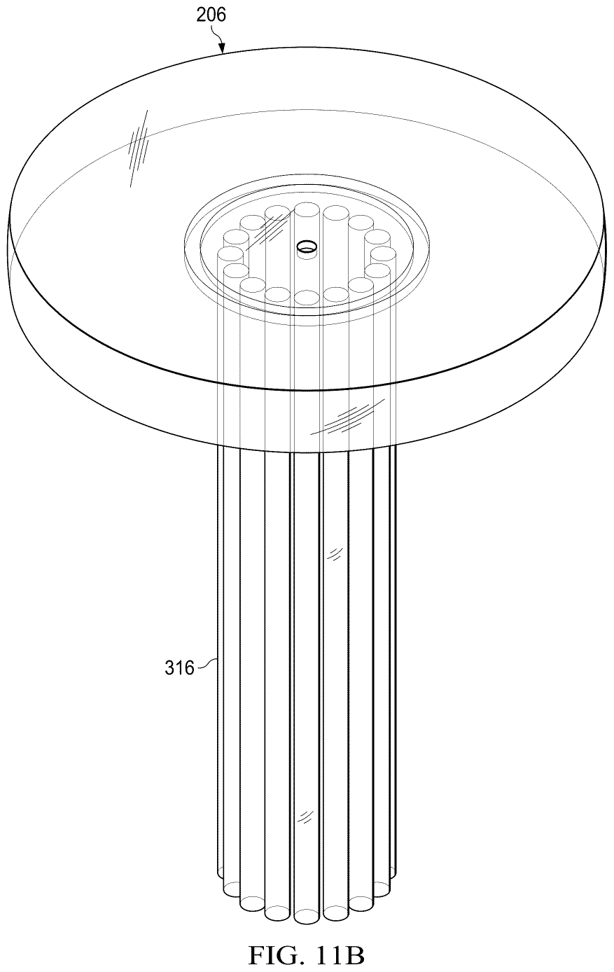

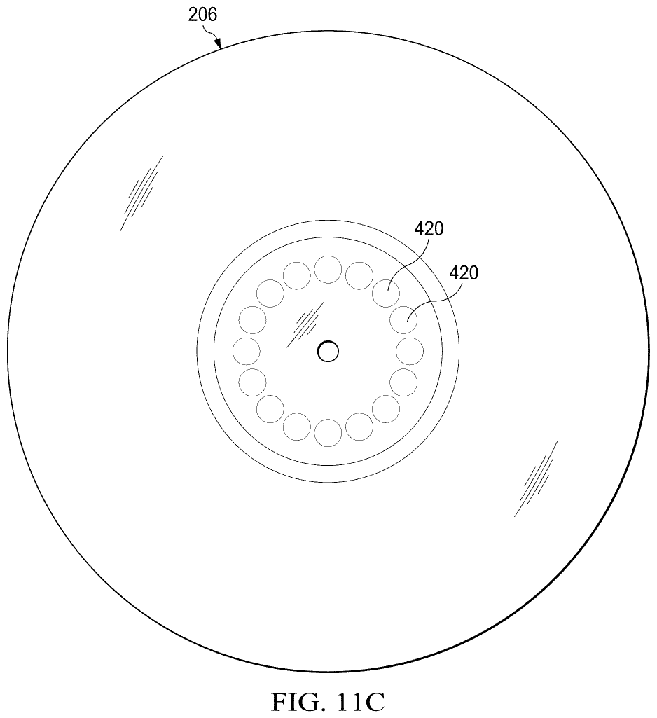

FIGS. 11A, 11B, and 11C illustrate various views of the dielectric components of the biconical antenna 200 with the set of N feed lines 210 of FIG. 3A, namely, including the dielectric member 206 and the dielectric insulator sleeves 316 of the coaxial transmission lines 310. FIG. 11A illustrates a front view of the dielectric member 206. FIG. 11B illustrates a top perspective view of the dielectric member 206. FIG. 11C illustrates a bottom view of the dielectric member 206, including coaxial interfaces 420.

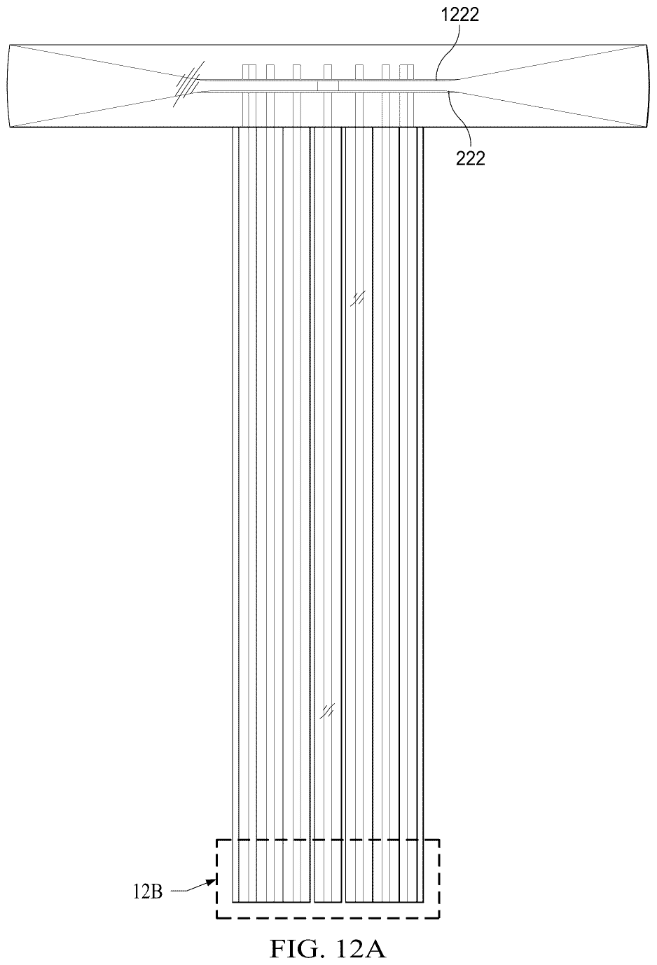

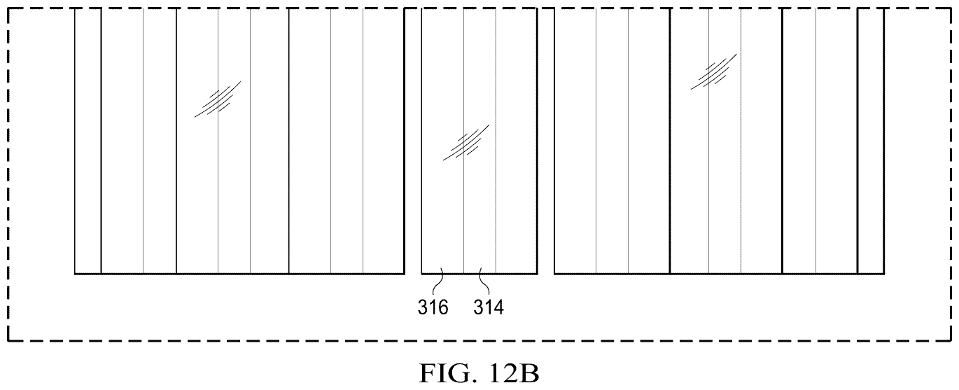

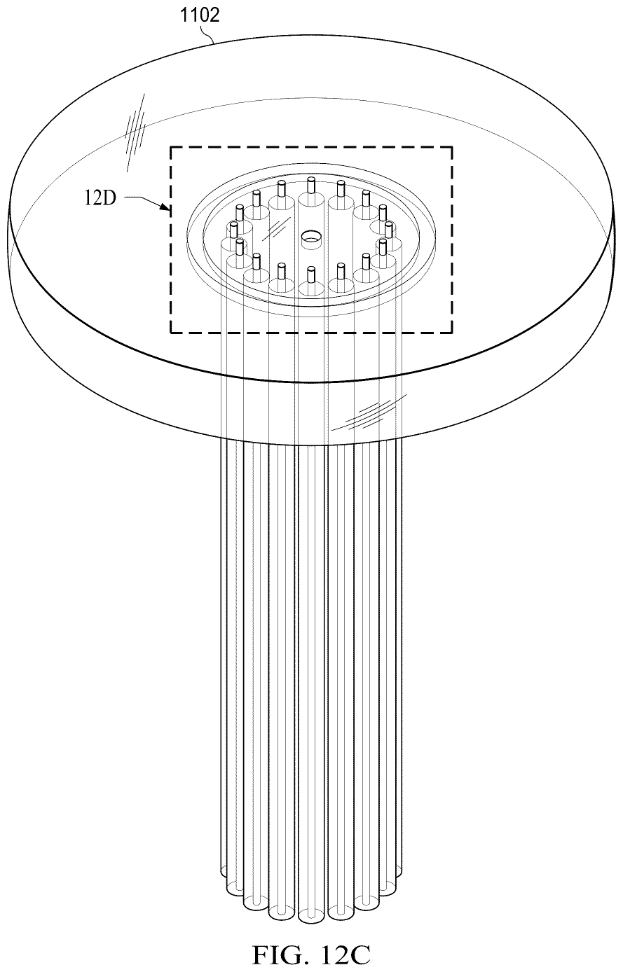

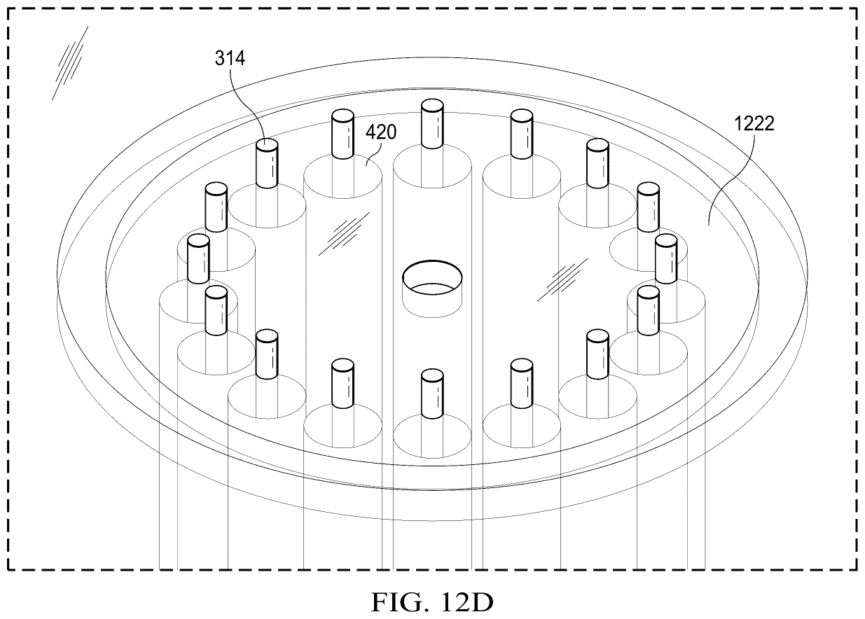

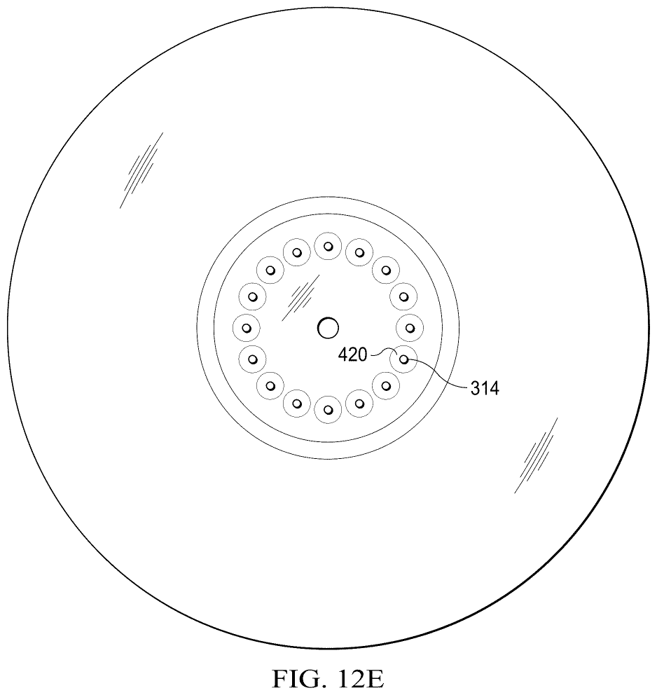

FIGS. 12A, 12B, 12C, 12D, and 12E illustrate the dielectric components of FIGS. 11A-11C together with the center conductors 314 of the coaxial transmission lines 310 shown, but without showing the outer conductors 312. FIG. 12A illustrates a front view, FIG. 12B illustrates a cutout view from FIG. 12A, FIG. 12C illustrates a top perspective view, FIG. 12D illustrates a cutout view from FIG. 12C, and FIG. 12E illustrates a bottom view of the dielectric member 206 with the center conductors 314 surrounded by the dielectric insulator sleeves 316. The coaxial interfaces 420 are shown in the bottom view of FIG. 12E and in the cutout view of FIG. 12D.

As described herein, the shape of the upper cone 204 is the same as the shape of the lower cone 202 in some embodiments as shown in FIGS. 2A-2B. Inverted relative to the shape of the lower cone 202, the shape of the upper cone 204 includes a flat bottom surface 1222 that faces the flat top surface 222 of the lower cone 202.

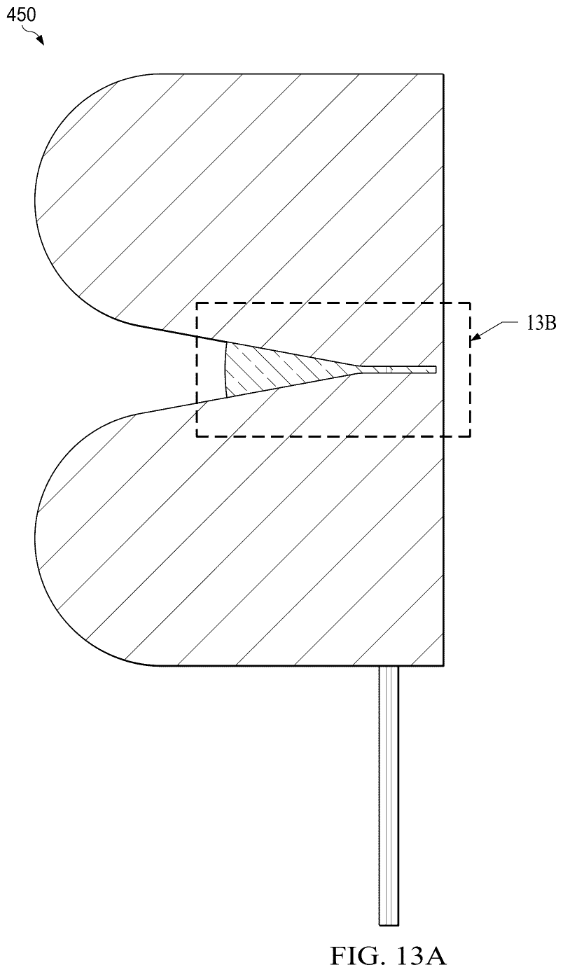

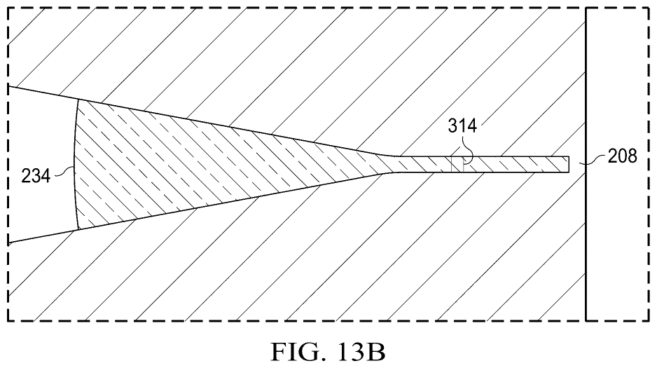

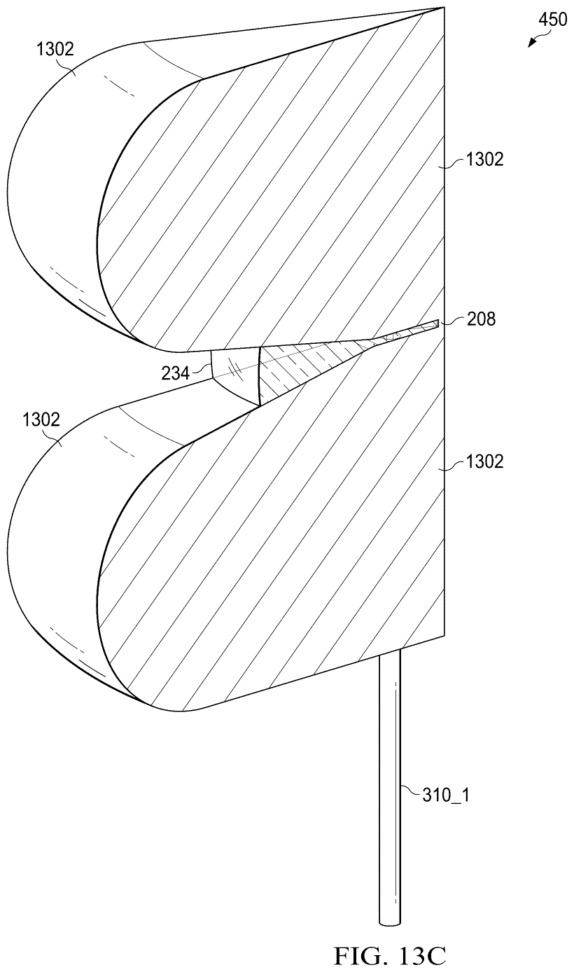

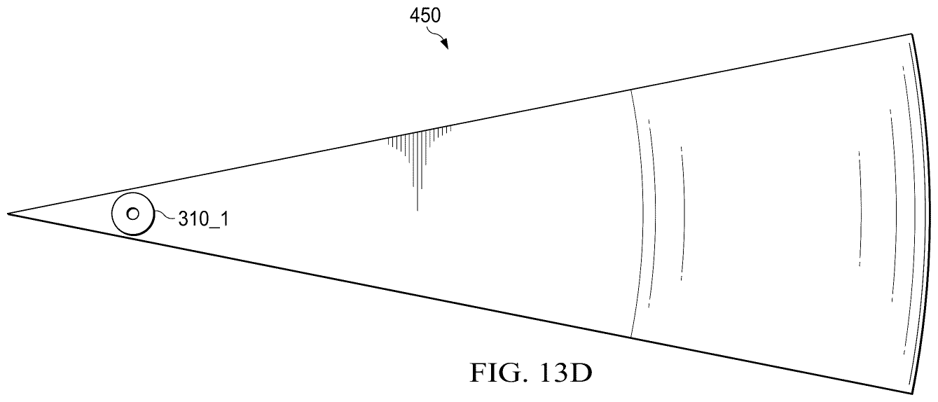

FIGS. 13A, 13B, 13C, and 13D illustrate various views of the sector 450 of FIG. 4C. FIG. 13A illustrates a front view of a longitudinal cross-section of the sector 450, including one-sixteenth of the shorting rod 208 and the center conductor 314 of the single feed line 310_1 passing through the dielectric member 206. FIG. 13B illustrates a cutout view from FIG. 13A. FIG. 13C illustrates a top perspective view of the sector 450. FIG. 13D illustrates a bottom view of the sector 450, including the single feed line 310_1. The side surface 234 forms the air-dielectric member interface.

Although FIGS. 1-13D illustrate examples of a MF-UWB biconical antenna 102, 200, 500, 600, 700, various changes may be made to FIGS. 1-13B. For example, various components in FIGS. 1-13D could be combined, further subdivided, or omitted and additional components could be added according to particular needs. As a particular example, rather than being a solid biconical antenna, the MF-UWB discone antenna 600 of FIG. 6A can be wire biconical antenna composed of first and second wires. The behaviors shown in FIGS. 9A and 9B are examples only and can vary depending on the implementation of the antenna.

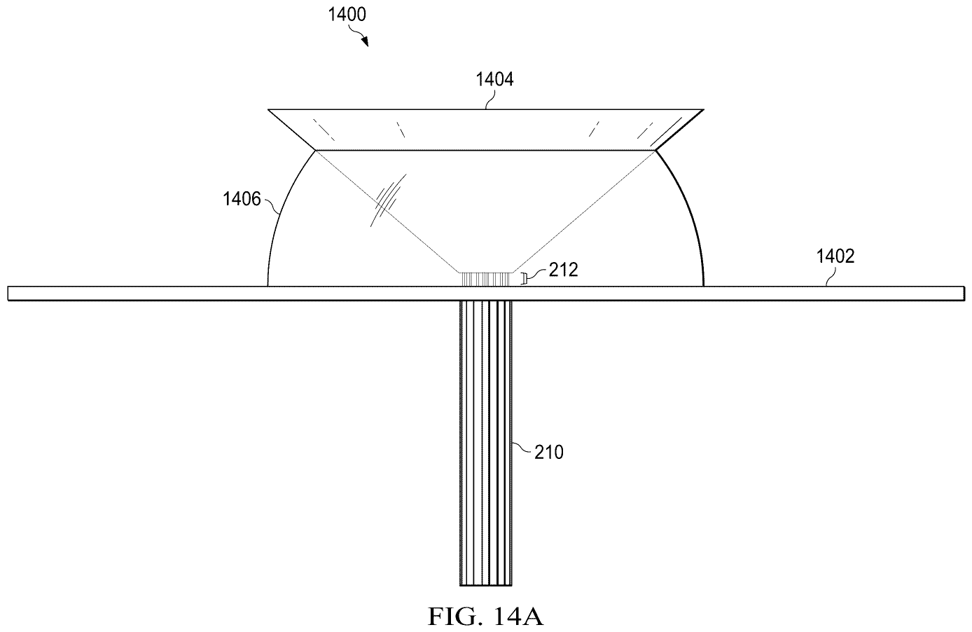

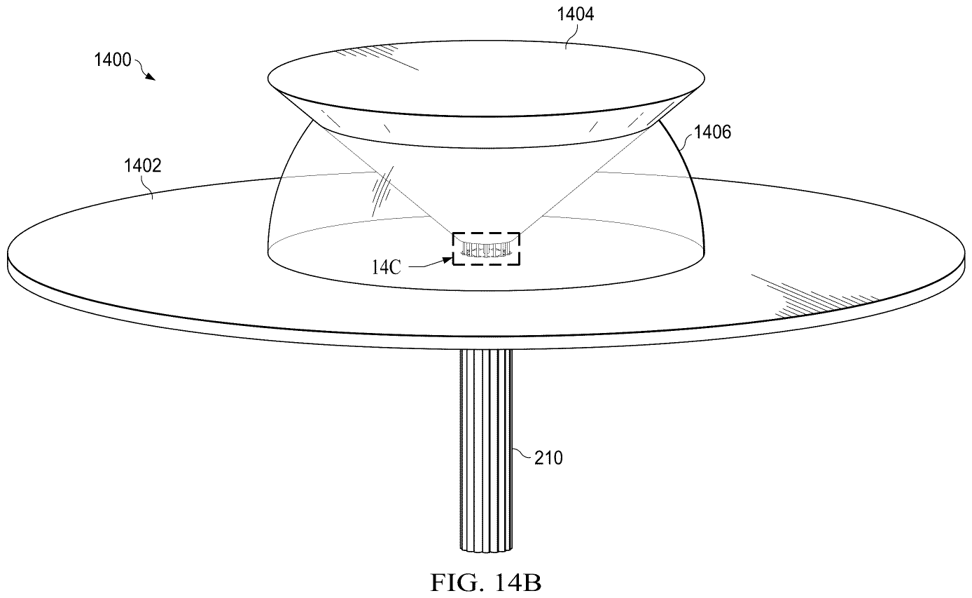

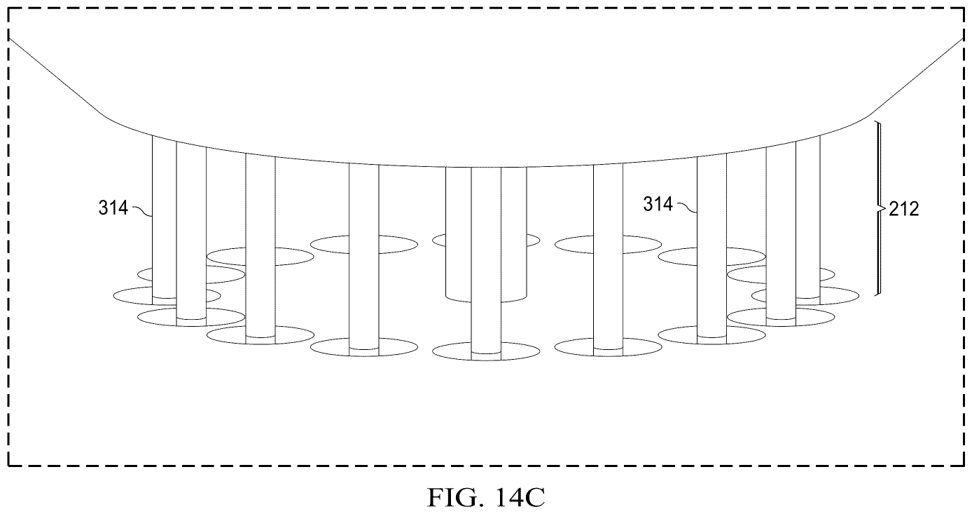

Those skilled in the art will appreciate that a monopole embodiment of the present disclosure can be realized by replacing the lower cone with a ground plane. A monopole is an antenna mounted over a ground plane. FIGS. 14A, 14B, and 14C illustrate various views of an example MF-UWB conical monopole (CM) antenna 1400 according to embodiments of this disclosure. FIG. 14A illustrates a front view of the MF-UWB CM antenna 1400. FIG. 14B illustrates a top perspective view of the MF-UWB CM antenna 1400. The MF-UWB CM antenna 1400 is similar to the solid biconical antenna 200 of FIG. 2A and includes the set of N feed lines 210 and antenna input interface 212. However, the lower cone is replaced by a ground plane 1402. FIG. 14C illustrates a cutout view from FIG. 14B.

The MF-UWB CM antenna 1400 includes a ground plane 1402, an upper cone 1404 positioned above the ground plane 1402, and a dielectric member 1406. The ground plane 1402 takes the place of the lower cone such that the outer conductor 312 of each coaxial transmission line 310 is electrically connected to the ground plane 1402 and each center conductor 314 is electrically connected to the upper cone 1404. The diameter of the ground plane 1402 can be greater than the diameter of the upper cone 1404.

Although FIGS. 14A-14C illustrate examples of a MF-UWB CM antenna 1400, various changes may be made to FIGS. 14A-14C. For example, various components in FIGS. 14A-14C could be combined, further subdivided, or omitted and additional components could be added according to particular needs. As a particular example, rather than being a solid hollow antenna, the MF-UWB CM antenna 1400 can be a wire antenna ad described with reference to FIG. 6A. As another example, the map 900 of electric field magnitude in FIGS. 9A and 9B can be the same or similar electric field magnitude distributions in and around the MF-UWB CM antenna 1400 of FIGS. 14A-14C.

It may be advantageous to set forth definitions of certain words and phrases used throughout this patent document. The term “couple” and its derivatives refer to any direct or indirect communication between two or more components, whether or not those components are in physical contact with one another. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An antenna comprising:
a lower cone;
an upper cone;
a dielectric member between the lower cone and the upper cone;
a shorting rod extended through the dielectric member and connected to the lower cone below the dielectric member and the upper cone above the dielectric member; and
an antenna input that includes a coaxial interface configured to:
connect a respective feed line among a set of multiple feed lines to the lower cone and to the upper cone; and
transfer an input power from the respective feed line to the antenna.

2. The antenna of claim 1, further comprising the set of multiple feed lines configured to:
receive multiple input signals, the input signals having input powers substantially equivalent to one another in amplitude and phase; and
conduct the input power to the antenna, thereby delivering the multiple input signals to the antenna;
wherein each respective feed line among the set of multiple feed lines includes a coaxial transmission line electrically coupled to the lower cone and to the upper cone through the antenna input.

3. The antenna of claim 2, wherein the coaxial transmission line of the respective feed line includes an outer conductor electrically coupled to the lower cone and an inner conductor that is electrically coupled to the upper cone and electrically insulated from both the lower cone and the outer conductor.

4. The antenna of claim 2, wherein:
the multiple input signals have substantially equivalent amplitudes and substantially equivalent phases to one another; and
the set of multiple feed lines is configured to output the multiple input signals to the antenna input.

5. The antenna of claim 1, wherein each of the multiple feed lines is spaced from a center of the shorting rod by a first uniform distance.

6. The antenna of claim 5, wherein the multiple feed lines are spaced apart from each other by a second uniform distance.

7. The antenna of claim 1, wherein the antenna is a discone antenna.

8. The antenna of claim 1, wherein the antenna is a wire biconical antenna.

9. The antenna of claim 1, wherein:
the antenna is a conical monopole antenna; and
the lower cone is a ground plane.

10. The antenna of claim 1, wherein the set of multiple feed lines includes sixteen or more feed lines.

11. A system comprising:
a set of multiple feed lines; and
an antenna including:
a lower cone;
an upper cone;
a dielectric member between the lower cone and the upper cone;
a shorting rod extended through the dielectric member and connected to the lower cone below the dielectric member and the upper cone above the dielectric member; and
an antenna input that includes a coaxial interface configured to:
connect a respective feed line among the set of multiple feed lines to the lower cone and to the upper cone; and
transfer an input power from the respective feed line to the antenna.

12. The system of claim 11, further comprising:
a power distribution manifold configured to distribute a first power of a first signal to multiple output channels;
wherein the set of multiple feed lines is configured to:
receive multiple input signals from the multiple output channels, the input signals having input powers substantially equivalent to one another; and
conduct the input power to the antenna, thereby delivering the multiple input signals to the antenna; and
wherein each respective feed line among the set of multiple feed lines includes a coaxial transmission line electrically coupled to the lower cone and to the upper cone through the antenna input.

13. The system of claim 12, wherein the coaxial transmission line of the respective feed line includes an outer conductor electrically coupled to the lower cone and an inner conductor that is electrically coupled to the upper cone and electrically insulated from both the lower cone and the outer conductor.

14. The antenna of claim 12, wherein:
the multiple input signals have substantially equivalent amplitudes and substantially equivalent phases to one another; and
the set of multiple feed lines is configured to output the multiple input signals to the antenna input.

15. The system of claim 11, wherein each of the multiple feed lines is spaced from a center of the shorting rod by a first uniform distance.

16. The system of claim 15, wherein the multiple feed lines are spaced apart from each other by a second uniform distance.

17. The system of claim 11, wherein the antenna is a discone antenna.

18. The system of claim 11, wherein the antenna is a wire biconical antenna.

19. The system of claim 11, wherein:
the antenna is a conical monopole antenna; and
the lower cone is a ground plane.

20. The system of claim 11, wherein the set of multiple feed lines includes sixteen or more feed lines.
